(19) United States
(12) Patent Application Publication
(10) Pub. No.: US 2002/0046071 A1
(43) Pub. Date: Apr. 18, 2002

(54) Business innovation method and system

(76) Inventors: Martin James Walker, Leighton Buzzard (GB); Ray Giles, Guildford (GB); Christopher Geary, Hungerford (GB); Christopher Wood, Huntingdon (GB); Adrian Stock, Farnharm (GB); Robert Kitchen, Colden Common (GB); Dag Tungvaag, Stavern (NO); Christopher Corcoran, Brightwell Baldwin (GB)

Correspondence Address: Richard P. Berg, c/o LADAS & PARRY, 5670 Wilshire Boulevard, Suite 2100, Los Angeles, CA, 90036-5679, US

(21) Appl. No.: 09/878,720

(22) Filed: Jun. 11, 2001

(30) Foreign Application Priority Data
Jun. 12, 2000 (GB) 0014251.3

(51) Int. Cl. G06F 17/60

(52) U.S. Cl. 705/7

(57) ABSTRACT

A business innovation park (10) is provided that has a plurality of distinct interaction zones (11-14) arranged as in a theme park and each providing resources and services in respect of a particular facet of developing a new business proposal from an initial idea to an execution plan. Preferably, the zone comprise a future-world zone (11), an innovation zone (12), a treasure-island zone (13), and a voyage-to-reality zone (14). A new business proposal is progressed around the park according to the state of the business proposal on leaving a zone just visited, the business proposal potentially re-visiting a zone one or more times as required for development of the business proposal. The park operator may provide park access on the basis of an equity option in any new business venture that may be created.

### FIELD OF THE INVENTION

The present invention relates to a business innovation park, system and method for developing new technology-based businesses.

### BACKGROUND OF THE INVENTION

FIG. 1 of the accompanying drawings shows a typical known business development process for taking an initial idea and turning it into a business plan ready for execution. As can be seen, the process comprises the steps of exploration and analysis of the idea, visioning how a business might be formed around the idea, modeling and architecting the business concept, and planning and then executing a business plan.

Such business development processes are often carried out by consultancy firms on behalf of clients and have traditionally extended over many weeks with a large number of visits between the client and the consultancy firm.

With the increasing need for rapid business creation and development engendered by the internet, a new type of business creation environment has evolved for technology-driven (primarily internet focused) businesses. FIG. 2 depicts this new type of business development structure, generally referred to as an “internet incubator”. As can be seen, this new structure is a synthesis of the services traditionally provided by venture capitalists and a standard business development consultancy. According to Mohan Sawhney, of the Kellogg Graduate School: “It's a new type of conglomerate that looks at cross connections and creates synergies that really mean something.”

It is an object of the present invention to provide an improved business innovation method and system for the development of new technology-based business proposals.

### SUMMARY OF THE INVENTION

According to one aspect of the present invention, there is provided a business innovation park comprising a plurality of distinct interaction zones arranged as in a theme park and each providing resources and services in respect of a particular facet of developing a new business proposal from an initial idea to an execution plan, the park further comprising a core area for informal interaction between users of the park.

By “theme park” is meant a park such as Euro Disney which has the following four theme zones: Frontier-land, Adventure-land, Fantasyland, Discovery-land. However, it is not intended that the business innovation park of the present invention be restricted to open-air park layouts (though this would be possible) and the primary embodiments of the invention concern interaction zones housed within a single building or a set of connected buildings. Additionally, “virtual” embodiments are also envisaged.

Preferably, the zones comprise:

a future-world zone for experiencing leading edge technologies and/or simulations of future technology-enabled scenarios of potential relevance to the new business proposal;

an innovation zone for envisioning and conceptually exploring the new business proposal;

a treasure-island zone for examining the business case for the new business proposal;

a voyage-to-reality zone for evolving an execution plan for realising the new business proposal;

the business proposal potentially changing as a result of the activities in a zone

Advantageously, an information technology infrastructure is linked to and available in all the zones and the core area for collecting, collating and presenting data about a business idea as it is taken through the zones, the information technology infrastructure being accessible both to park users and to consultants operating in the park.

According to another aspect of the present invention, there is provided a business innovation method involving providing a plurality of distinct interaction zones arranged as in a theme park each with resources and services in respect of a particular facet of developing a new business proposal from an initial idea to an execution plan, and progressing a business proposal around the park according to the state of the business proposal on leaving a zone just visited, the business proposal potentially re-visiting a zone one or more times as required for development of the business proposal.

Preferably, respective zones are provided for:

experiencing leading edge technologies and/or simulations of future technology-enabled scenarios of potential relevance to the new business proposal;

envisioning and conceptually exploring the new business proposal;

examining the business case for the new business proposal;

evolving an execution plan for realising the new business proposal;

the business proposal potentially changing as a result of the activities in a zone.

Advantageously, the method further involves collecting, collating and presenting data about a business proposal as it is taken through the zones, the information technology infrastructure being accessible both to users and to consultants.

### BRIEF DESCRIPTION OF THE DRAWINGS

A business innovation method and system embodying the invention will now be described, by way of non-limiting example, with reference to the accompanying diagrammatic drawings, in which:

FIG. 1 is a diagram of a first known business development process;

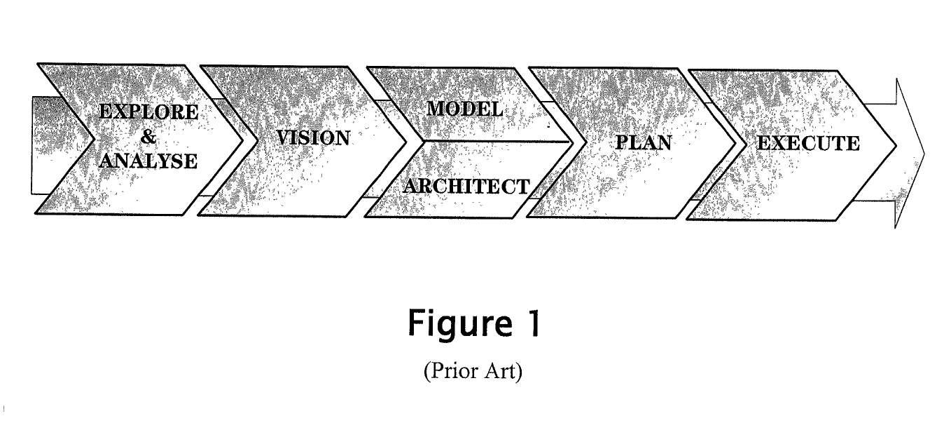

FIG. 2 is a diagram of a second known business development process;

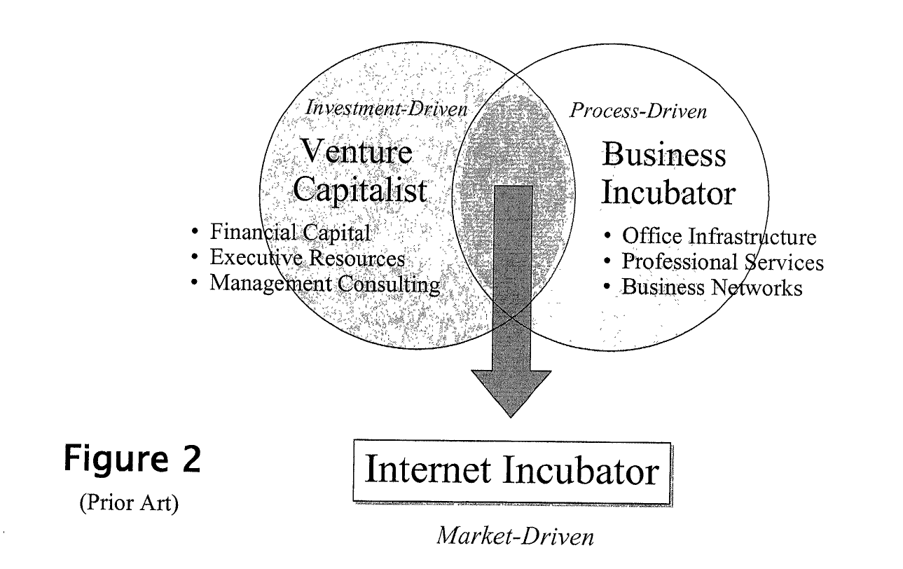

FIG. 3 is a schematic diagram of a physical business innovation park embodying the present invention;

FIG. 4 is a diagram illustrating the five zones of the FIG. 3 park;

FIG. 5 is a diagram illustrating the main planned activities (“rides”) in each zone of the FIG. 3 park;

FIG. 6 is a diagram illustrating part of the IT infrastructure of the FIG. 3 park;

FIG. 7 is a diagram illustrating the data space organization with the FIG. 7 IT infrastructure;

FIG. 8 is a diagram illustrating a Welcome Page of a virtual embodiment of the business innovation park of the invention; and

FIG. 9 is a diagram illustrating an Innovation Zone page of the FIG. 8 virtual park.

### BEST MODE OF CARRYING OUT THE INVENTION

The embodiments of the present invention to be described below uses a theme park idiom to provide a stimulating and versatile environment for innovating new businesses—the environment thus provided is hereinafter referred to as the “Innovation Park”. Because of the great value of direct human-to-human interaction, the Innovation Park environment is preferably a real-world environment though, as will be seen, remote and virtual extensions and implementations of the environment are also possible.

The Innovation Park environment is an innovation ecosystem and is run by an operator who provides experts, facilitators and advisors, generically referred to below as “consultants” regardless of their actual role. The operator makes the facilities of the Innovation Park available to a user—a group of one or more “participants”—that has an idea for an e-business (or possibly some other type of business) which the user wishes to develop towards implementation.

As will be more fully described below, the Innovation Park comprises four themed zones and a central hub area or zone, this latter providing an area where participants can meet up, interact and exchange ideas in an unstructured way. The central zone can thus conveniently be implemented as a refreshment area providing a “coffee bar” or “pub” atmosphere. The central zone can also serve as a coordination center where the participants can access and review their progress as electronically documented by the consultants.

The user group is guided around the four zones of the Innovation Park by the consultants to develop the original business idea. Whilst the group will probably start in one zone (“Future World”—see below) and progress through all the other zones to end up at the business launch zone (“Voyage to Reality”), there is no predetermined route to follow through the zones and a group may need to revisit one or more zones several times before completing the process.

The operator makes the facilities of the Innovation Park available either on a “time and materials” basis (in which case the consultants merely play a facilitator role) or, where the consultants are to play a more active role and contribute significant intellectual capital, potentially on an equity-stake option basis in respect of any new business that might emerge from the use of the Innovation Park. Such matters will generally be decided up front before any group enters the park. Where the arrangement is one of a potential shared reward, the operator will normally be required to decide whether or not to take up this shared reward when the group concerned has finished its session of use of the park.

It is possible to operate the Innovation Park with only one group using its facilities at a time. However, substantial benefit can be obtained where several groups use the Park together since informal meetings between participants from different groups (particularly in the central zone) are likely to generate new approaches and concepts for both. Of course, the groups would need to be initially vetted to avoid conflicts of interest.

Another important feature that is preferably made available is the possibility of introducing third parties with particular expertise needed to make a proposed business fly—such parties can be introduced on a stake holder basis with the agreement of the initial group.

A more detailed description of the main components of the Innovation Park will now be given.

### Four Themed Zones of the Innovation Park

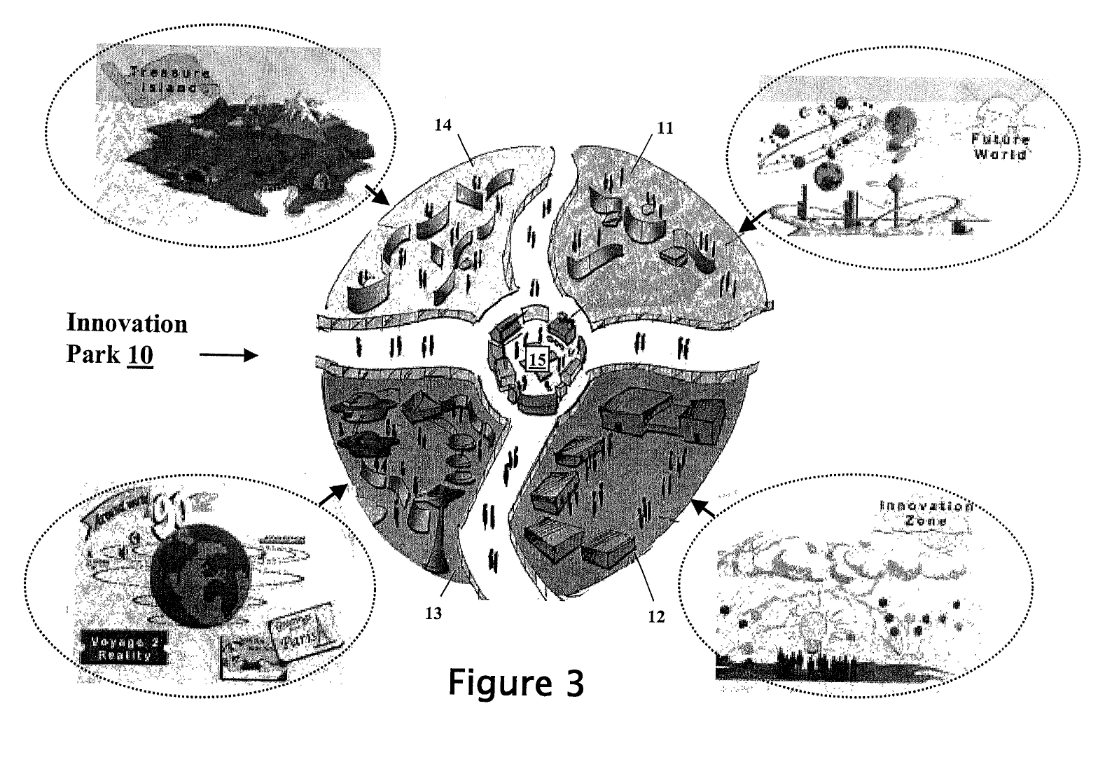

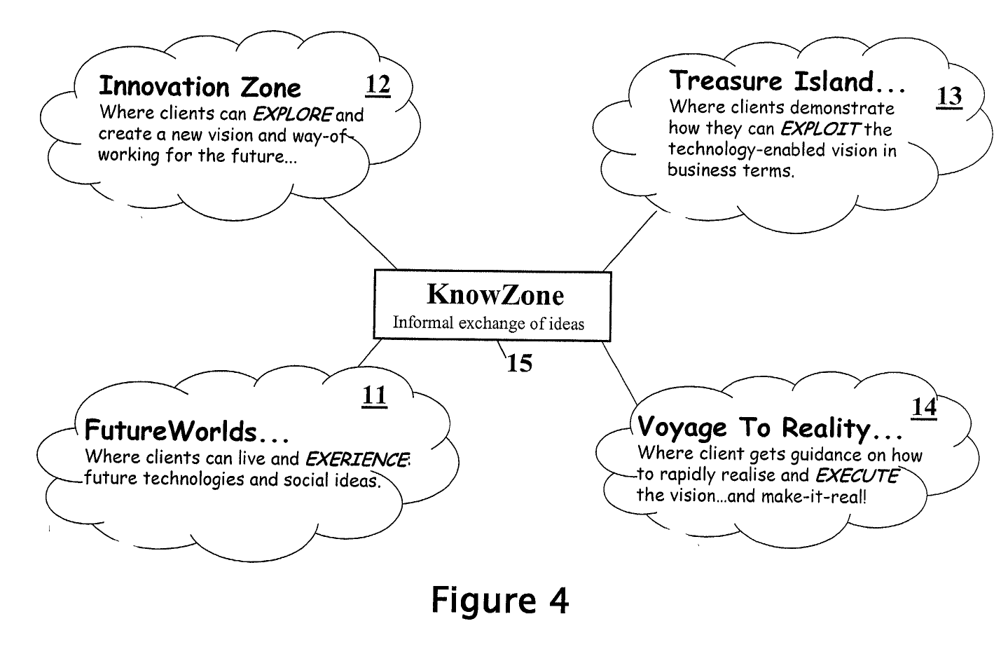

The Innovation Park depicted in FIGS. 3 and 4, is a real-world site 10, here shown housed in a single building space, and comprises the following four themed zones with the planned activities (or “rides”) in each zone all being based on a common theme with supporting images, props and terminology to stimulate the imagination of, and encourage the involvement by, the participants. These themed zones are:

a future-world zone 11 for experiencing leading edge technologies and the latest advances in social and thinking; simulations of future technology-enabled scenarios of potential relevance to a new business proposal can also be staged;

Example Theme: Space (space travel, planets, etc.)

an innovation zone 12 for envisioning and conceptually exploring the new business proposal through activities such as brainstorming, storyboards of an envisioned proposal, scenario enactment, noting concerns and issues;

Example Theme: Weather

a treasure-island zone 13 for examining the business case for the new business proposal, what are the threats and why is it better than others;

Example Theme: Desert island

a voyage-to-reality zone 14 for evolving an execution plan for realising the new business proposal;

Example Theme: Travel

Further details of each themed zone are given below.

### Future World

Environment (What is there)

Value Web Connections.

Current web and possible connections

Reference Collateral

Books, Internet, etc

Guided Tour of Future

Examples of future scenarios

Experience (What do You do in the Zone)

Scanning of Systems

Workflow, chaos theory, ecosystems

Research

In domain, non-related domains

Trend Spotting

Technology, environment, cultures

### Innovation Zone

Environment (what is there)

Iterative Approach

Multi-spin with participants together

Reference Collateral

Technologies, Experts, metaphors

Brainstorm Environment

Whiteboards, playback, real-time capture

Experience (What do you do in the zone)

Describe Alternate Perspectives

Technology, people, process, capability

Consider Alternate time Horizons

In domain, non-related domains

Produce Stories (Scenarios) that bring it to life

Roles Perspective

Capture Graphic Representation

Cartoon, animation, video, theatrical play

### Treasure Island

Environment (What is there)

Business Game

Components to build a game, “Lego” bricks

Reference Collateral

Models, Simulations

Experience (What do you do in the zone) Explore Business Models

Technology, people, process, capability

Design a business Game

Build a business model and rules

Simulate the game

Iterate round the model

Capture Learnings & Create a map

Cartoon, animation, video, theatrical play

### Voyage to Reality

Environment (what is there)

Examples

Reference cases, Examples of Knowhow ideas implemented

Reference Collateral

Benchmarks

Experience (What do you do in the zone)

Build a Prototype-proof of business model

Prove a viable concept, technology+business+process angles

Build the Programme Plan

Market Test

Customer input

Balance Benefits v Risk v Time to market

### The KnowZone

The central zone 15 (like “Main Street” in Euro Disney) is called the “KnowZone” and is where the participants can relax, discuss progress and meet others in the Innovation Park; the meeting and sharing of ideas here is often where breakthroughs can occur. The KnowZone also serves to link the four zones together. Consultants based here provide an overall monitoring role and carry out value assessments on on-going projects. The KnowZone further acts as an intellectual capital resource where consultants are available to provide skill and know-how into projects as required or to call in the necessary resources from outside should this be needed. Refreshments may also be available.

### Rides and Routing

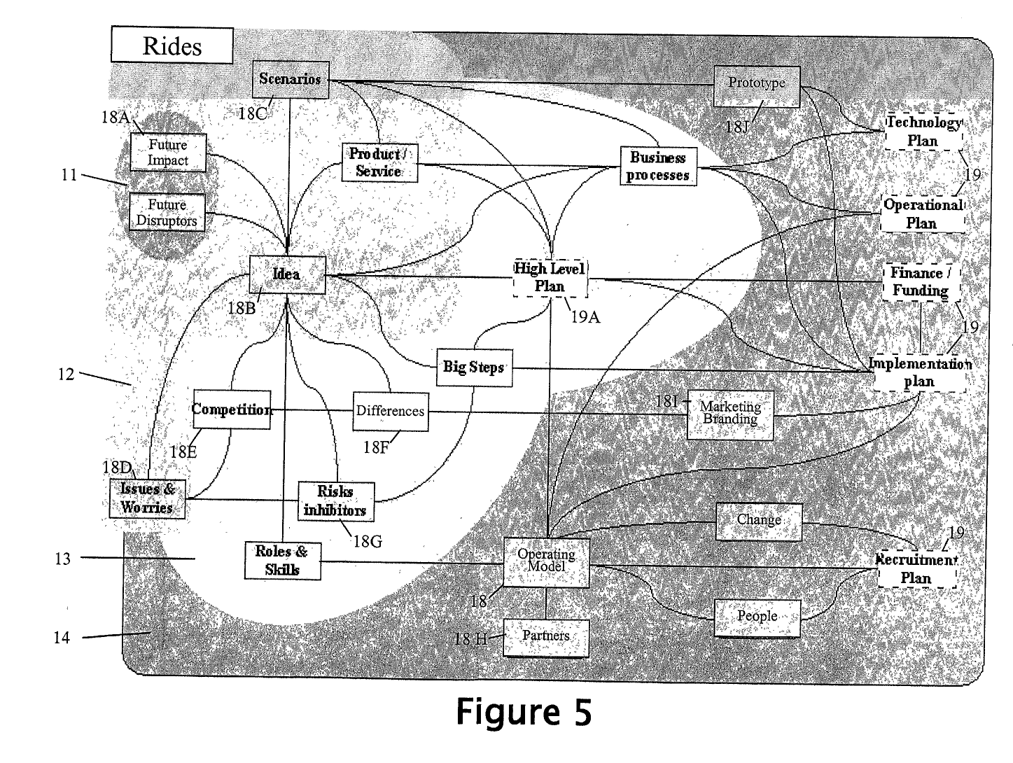

FIG. 5 depicts the main planned activities in the four themed zones 11-14, these activities being shown by rectangular boxes 18 and 19, the dashed-outline boxes representing activities that generate key deliverables (plans). It is these planned activities 18, 19 that are themed according to the theme of the zone in which they occur. For example:

Future World Zone (theme: Space)

| | |
|---|---|
| “Space Junk” ride | examples of products and technology are used to |
| | stimulate discussion about good ideas that failed, |
| | perhaps because of bad timing (18A); |
| “Wireless | wireless devices are used to encourage participants to |
| universe” | consider their business idea within a world of wireless |
| | devices |

Innovation Zone (theme: Weather)

| | |
|---|---|
| “Bolt from the | idea generation and capture (18B) |
| Blue” | |
| “Clear Sky | participants work on scenarios for idea exploitation |
| Revelations” | (18C); |
| “Grey Clouds” | participants brainstorm inhibitors to their business idea |
| | which they then “park” for further consideration later |
| | on (18D); |

Treasure Island Zone (theme: desert island)

| | |
|---|---|
| “Olde Spyglasse | checking on the activities of potential competitors |
| Hill” | |
| “Twin Peaks” | identification of differentiators is the ride (18E); |
| “Deep Canyon | a risk assessment tool that aids participants in |
| Swamp” | identifying risks and responses (18G); |
| “Fortune Springs” | generation of the outline business plan (19A); |

Voyage to Reality (theme: travel)

| | |
|---|---|
| “All Aboard” | partners and suppliers identified and/or solidify their |
| | corporate team (18H); |
| “Name that Ship” | participants establish branding (18I); |
| “Test Drive” | Consultants help to build a prototype of the potential |
| | business, such a website, an electronic version or |
| | model of their idea—this helps participants visualize |
| | their product (18J). |

It will be appreciated that the rides and how they are themed (including the high-level them of each zone) can be varied from the foregoing examples.

In FIG. 5, the lines drawn between the rectangular boxes indicate possible transitions (routes) from activity to activity as participants move through the park.

The consultants (including any consultants travelling the park with a group) determine what zone should next be entered by a group and to this end, consider entry questions of the type set out below; depending on the answers received, the consultants make decisions on the matters indicated. These entry criteria is only one mechanism and used implicitly by the consultants; other mechanisms, such as giving users a set number of zone tickets, are also possible.

### Park Entry

### QUESTIONS

1. WHAT—Describe the idea—what is different and new; what is the industry rule you are breaking?

2. WHERE—Describe the market you are aiming at

3. WHY—Describe the benefit/need you fulfill

4. HOW—Describe the pieces of the proposed solution & how you will apply your capabilities

5. WHEN—Outline the time scales you wish to work within & why

6. VALUE—What is the Intellectual Capital (IC)/Intellectual Property(IP) being declared?

7. NEED—Is this collaboration or short term hire of park space?

### DECISIONS

(A) Go/No Go

(B) Which zone to go to ?

(C) What is the recommended route map to follow in a zone—some or all elements?

(D) What investments and resources are needed? (people, things, time, money)

(E) How does it fit the park operator portfolio of business proposals being supported?

(F) Does it fit the current park incumbents (if any)—no conflict of interest

### Entry to Future World

Entry to this zone is less controlled than the other zones and is often the starting point for a group using the innovation park. Groups may re-enter this zone at any stage for new experiences.

### Entry to Innovation Zone

1. Scanning sufficient?

2. Research sufficient?

3. Assessed value web for potential collaborators?

4. Valid Trend Analysis?

5. Simulation excites, catches imagination?

6. What IP/IC are you prepared to share or trade?

### DECISIONS

(A) Go/No Go

(B) Where to go to (zone or solution or other company)?

(C) What is the recommended route map to follow in next zone—some or all elements?

(D) What investments and resources are needed? (people, things, time, money)

(E) Review and capture IP/IC and value web updates

### Entry to Treasure Island

### QUESTIONS

1. Sufficient viewpoints considered (people, process, technology)?

2. Depth of perspectives sufficient?

3. Multiple time horizons considered?

4. Is idea different enough?

5. Are scenarios complete, consistent, compatible from different perspectives?

6. Does graphic image excite?

7. Are time scales clearly defined?

### DECISIONS

(A) Go/No Go

(B) Where to go to (zone or solution or other company)?

(C) What is the recommended route map to follow in next zone—some or all elements?

(D) What investments and resources are needed? (people, things, time, money)

(E) Review and capture IP/IC and value web updates

### Entry to Reality

### QUESTIONS

1. Clear business model (Market, Offer, Financial projections)?

2. Well-defined route map?

3. Well-defined resource/capability requirement?

4. Commitment from Organisation available?

### DECISIONS

(A) Go/No Go

(B) Where to go to (zone or solution or other company)?

(C) What is the recommended route map to follow in next zone—some or all elements?

(D) What investments and resources are needed? (people, things, time, money)

(E) Review and capture IP/IC and value web updates

### Park Exit

As an idea has matured, decisions need to be made as it leaves the Park. For example, if the park operator agrees to create a company, the operator needs to decide which consultant monitors the operator's interest in the new company.

### QUESTIONS

1. Idea well formed?

2. Idea proven feasible/proven business model?

3. Market tested?

4. Well-defined resources?

5. Is balance right? Risk v Benefit v Time to market

6. Programme Plan sound?

### DECISIONS

(A) Where to go to (zone or solution or other company or new company)?

(B) What investments and resources are needed? (people, things, time, money)

(C) Review and capture IP/IC and value web updates

(D) Assign custodian to monitor new assets

### Competences/Roles

The competences and roles normally provided by consultants and participants in the Innovation Park are:

| | |
|---|---|
| Scanning & Idea | Collect, filter & combine ideas -> Opportunity |
| Combining | seekers/market-makers |
| Connecting & | Idea Merchants that use the value-web to build the |
| attracting | innovation teams |
| Value Assessment | Assess and allocate IP/Business/Social value |
| Experience Enablers | Set up the park |
| Innovators | Participate in the web to innovate the ideas |
| Garage Builders | Build and prove business ideas (Vizualisers) |

### The I.T. Infrastructure

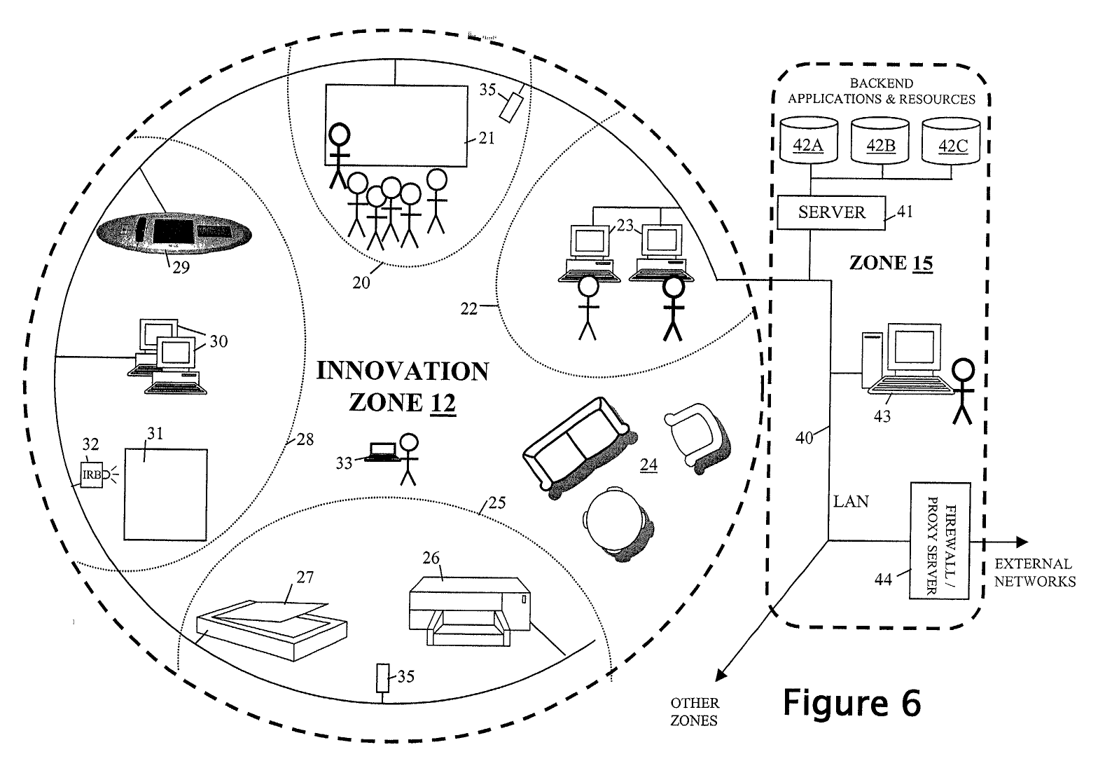

FIG. 6 depicts part of the IT (Information Technology) infrastructure of the Innovation Park. The IT infrastructure is based around a LAN 40 that connects together computers and other devices located in all the zones 11-14 as well as in the central zone 15 to facilitate the collecting, collating, analysis and playback of data gathers about a business proposal being developed in the park. Business proposal (or “project”) data is stored on database 42A which is located in central zone 15 along with application servers (42B, 42C) that provide tools for carrying out various tasks, including analysis tasks, on the data. For convenience of use, a web-based interface is provided for user access to data and applications, web server 41 serving as the interface to the devices 42 for users connected to LAN 40.

Central zone 15 also houses consultant PCs 43 (consultants are shown as bold stick persons in FIG. 6, users being ordinary stick persons). The consultants use PCs 43 for processing and organizing project data. Firewall/proxy-server 44 provides secure external access, typically to internet web resources, both for the users and for the consultants. In addition, remote group members can participate via the firewall.

FIG. 6 shows a typical range of LAN-connected devices that are available to participants in the Innovation Zone 12. Thus, in sub-zone 20 where a facilitator consultant is conducting a brain-storming session, an electronic white-board 21 is provided that can be used to capture information as notes (including diagrams) and send it to the project data space on database 42A or for printing (see below). A sub-zone 22 has a group of PCs 23 where participants can work individually to access the project data on database 42A and manipulate using either tools pre-loaded on the PCs or downloaded from one of the application servers. Participants can also use PCs 23 to access external web resources or data in their own office IT systems, or to communicate with remote parties.

Sub-zone 25 provides general input/output devices such as printer 26 and scanner 27 for use by participants and consultants working in the zone 12.

Sub-zone 28 provides various other devices, namely a guided browser device 29 for accessing specific web-based resources relevant to the project; PCs 30 set up for specific demonstrations, and a display area 31 for items with access to information about the items being available at a web URL that is being broadcast by an infra-red beacon 32.

Participants are equipped with hand-held devices 33 that can be used for data input/output. These devices are, for example, equipped with infra-red receivers enabling them to capture the URLS broadcast by beacons 32 and then use the URLs to access the relevant information site. The infra-red connectivity of devices 33 can also be used to provide LAN network access and to communicate directly with other devices. The devices 33 can also be provided with means enabling their location to be tracked (a number of systems exist that permit location tracking, as is well known to persons killed in the art). Location tracking of the devices enables location relevant data to be pushed to devices—for example, if a participant is detected as present in the area 28, information could be pushed to the participant's device 33 suggesting what demonstrations might be of interest (possibly in dependence on previous interests indicated by the participant and/or the current status of the project).

Web cameras 35 provided around the zone enable remote participants to see what is happening and to involve themselves in an appropriate manner.

Innovation zone 12 also includes an area 24 for relaxation and informal communication.

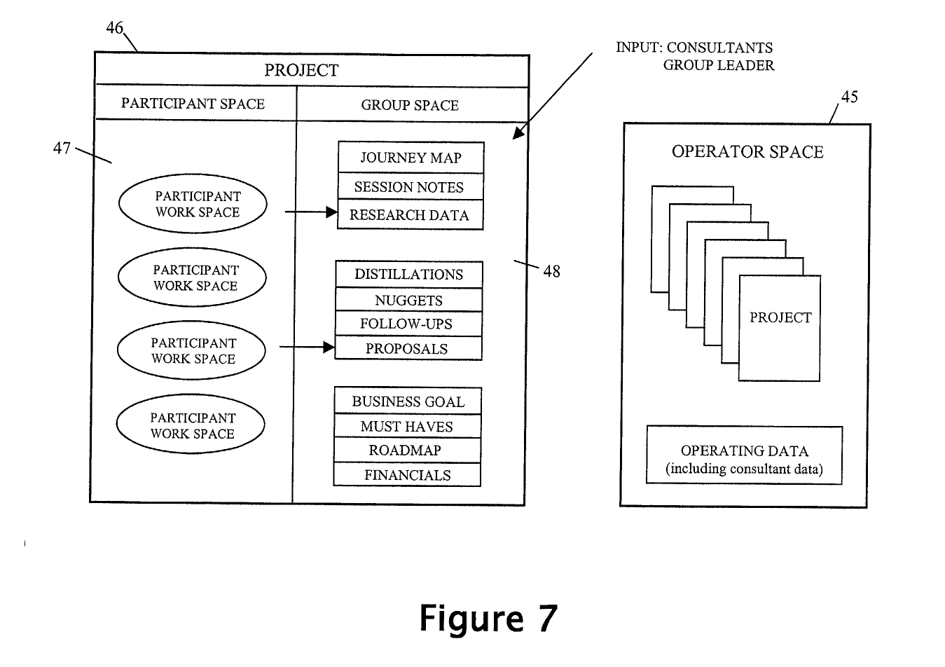

FIG. 7 depicts the project data space 46 on database server 42A. This data space is divided into work spaces 47 for each individual participant (and to which only the participant has access), and a group work space 48 to which all participants have read access and limited write access. The group space holds, inter alia, the following types of information:

a journey map of the group's progress to date through the park;

all notes captures by facilitators (or group leaders) at group sessions, these notes conveniently being accessible via the journey map;

research data of general relevance, this data being, for example, posted by a participant after research or a consultant working in the central zone 15 on the project;

distillations of the notes and research data;

“nuggets” (key ideas, concepts) considered important by the group;

follow-up items;

proposals which individual participants think are worthy for consideration by the whole group;

a statement of the business goal that is being worked towards (this may changes during the course of the visit and it is important that participants can remind themselves of the current direction);

agreed “must haves” for achieving business success;

roadmap for getting the business going;

financial data on the proposed business.

It will be appreciated that other types of data can also be provided. Input of data to the group space will generally be controlled by a facilitator consultant or a group leader (apart from the posting of items by participants form their work areas, noted above).

The park operator also has a space 45 on database server 42A for each project, this space being accessible to the consultants. The operator data space also includes operating data such as a list of consultants that can be called upon to give advise in specialist areas.

### Involving Others

As already indicated, a group may have one or more of its participants remotely located and joining in with the rest of the group by the use of IT resources. This widens the group's available viewpoints and expertise beyond the members physically present.

A group using the Park gains insights and know-how not only by its internal interactions bur also by its interactions with the Park's consultants and with the data available through the IT infrastructure. However, it is envisaged that substantial additional benefit will be obtained by arranging for interactions with other parties, including:

other park users;

a visiting consultant or invited exhibitor;

an external party selected on the basis of their ability to assist in implementing the business proposal;

previous users of the Park who may have continuation sessions running in nearby “incubator” offices or have posted their interest in certain areas of development.

These other parties contribute to the value web of the group.

Of course, where others contribute to the building of a business proposal, the issue arises as to whether they are entitled to a share of the rewards that it is hoped the proposed new business will create. These matters can be quite difficult to sort out if left until after the event and one role of the Park's consultants is to ensure agreement between parties of the basis of any collaboration. This basis can range from a free license for each parties to use ideas input by other parties for their current business proposal, to a more formal option for a shared reward in any business created as a result of the collaboration.

As already indicated, the park operator may have as an objective the building of a portfolio of shared rewards in businesses developed through the Innovation Park, the justification for taking such stakes being the substantial input of intellectual capital from the Park's internal consultants into the business development process.

In order to foster the working together of companies with related interests, the Park operator can arrange for special focussed events (say, for a week) where groups interested in the event focus are invited together with companies that can provide specific services in that area. Additionally, external companies can be invited at any time to exhibit in the Innovation Park.

### A Run-Through Example

This section outlines the visit of a client group to the Innovation Park to develop their new business idea during the course of several days.

“Arrive by bus or car at the Innovation Park. Drop coats and bags, etc into the cloakroom. See stimulating pictures, or moving images on the walls of the reception area.

Mill around in the store, looking at all the artefacts, books, pictures laid out. Have coffee & a bun. Use the info-kiosks that are dotted around to see favorite news, sports, etc. These also contain information on the local area such as restaurants, bars, taxis, stores/malls, etc. The sponsors for the event meet with The Park facilitators, and confirm that all the materials they were to bring have been uploaded onto The Park's web site. This means that it is instantly available at any time by the group from any of the access devices. However, access to this material is controlled by the facilitator to be available at the appropriate time (or not if the group discovers new directions)

Call to order by facilitator—in large group—confronted by large curved boards (blank). Facilitator explains the concept of The Park (Four Zones). Logistics are explained also.

The group is currently in Future World, and as such has access to some new technologies all around them. A demonstration of a Palm Pilot (or Hewlett-Packard Jornada or similar device 33) activating a web site which is projected onto a curved wall, or on one of the monitors. Explanation of how the device works and how it can be used to access and share information anywhere in The Park. The Park crew (that is, the consultants and their assistants) then hand out a device to all participants. These devices are personalised to the group for this visit to The Park—all web links are pre-selected to be useful, etc. The participants may purchase (or get for free) the devices 33 at the end of the experience.

The group has 30 minutes of playing with the environment, testing ways of finding, accessing and sharing information.

The group is then introduced to the Innovation Zone. The group is sent off to do exploration and research activities. Each focus area is themed and identifiable as belonging to one of the four zones. For instance, there may be an area with working practices, or the way we work. There will be some journals, articles, books, toys, etc associated with work, and some conceptual ideas that might have been developed by previous teams. This will have an info-kiosk in it with a “work” home page. A series of links will allow the visitor to look at relevant journals, articles, news, web sites, etc. The cool devices are used whenever possible here. We are requested to leave a comment in each area. Rather than writing stuff down, we find relevant articles on the web and print it to the nearest printer (there are loads of these all over The Park).

Most of the “work” of this group is done in the Innovation Zone. All the drawings, sketches, scribbles, etc that are put on the whiteboards during any session, are photographed by the Crew, uploaded onto the group web site. This means that anyone can view any image from anywhere using their cool-device, and can print them out at any time.

During Day Two, when the group is forming ideas on what direction they want to follow, there is an injection of ideas. This comes from the Future World, (and maybe the Treasure Island). The group is then taken (at the appropriate time) into the relevant zone for this injection. The relevant part of the zone is constructed as a “library” such that the groups are tasked to explore them and discover nuggets of stuff for themselves.

In Future World, there is a series of showcase examples of technologies in the environment that could have an impact on their situation. The group can use their own devices 33 to interact with the applications.

In Treasure Island, the area is stocked with posters of previous innovative business models, InfoStations with business assessment tools (applications with tools to assess things), examples of previous visitors to the area, other business models and justifications discovered here. The group can use their own devices 33 to interact with the applications.

During all group discussions at the whiteboards, any participants or members of the value web who are working remotely have access to the group discussions. Many web cameras are positioned around the area looking at different views, and a large monitor above the main whiteboard is displaying all comments typed by the remote participants. A remote person can see the text notes (taken by the Crew) appearing as they are typed, and all or selected views from the webcams 35. The remote person can offer comments to the group. If the remote person needs to, they can show pictures or examples of ideas/work from their PC to the entire group. In this way, although the remote person is not in the room, they can communicate and feel part of the discussions and help make progress. When there is no group discussion around the main whiteboard, the remote people can still watch what is happening, and can still make comments, but will not receive live transcriptions of discussions.

Towards the end of Day Two, the group will be starting to form conceptions of what the idea is. They should also be building a (mental at least) picture of the realisation of this idea. The job of the Crew at this stage is to listen to what is taking shape and begin to formulate the prototype solution. This may take the form of a process map, which will model the business processes discussed, and can then be used to play “what if” scenarios. Or the prototype may take the form of a web site where the idea is taken to production and launch very quickly. This web site will include example images, themes, logos, etc as well as the required functionality. One or two models could be built to represent different viewpoints or scenarios of use for the idea. All this work will be performed in the Voyage to Reality area. In here, there is a series of workstations (desks, PCs, etc) for the Crew to initially construct the prototypes.

At the start of Day Three, as the group enters, the models are visible of the InfoStations 29 in The Park. The group is permitted to play with them and experiment with the ideas before the session continues with (maybe) demonstrations of the ideas and implementations.

Day Three is the “make it happen” day. A great deal of these activities occur in the Treasure Island. An ANDmap is constructed by the group to define the high-level overall plan to launch the idea.

The group is guided through some of the more relevant tools and parameters to make the idea a reality. The group needs to

decide the proposition,

build a business case,

return on investment check

marketing plan

legal positions

operating model

In Treasure Island, the group encounters other, possibly external, consultants who focus most of their time in Treasure Island. As all are part of the big value web, they share ideas and thoughts. This creates a bigger knowledge pool that just the group.

Once the prototypes (or models) have been discussed, the group will work (in small teams with focus) with the Crew to refine, adjust tweak the models before a second showing to the whole group. As these models are refined, the Crew is responsible for ensuring that the underlying technologies and design will allow the models to be implemented and launched with little further effort. The models will take the form of digital process maps, paper/whiteboard storyboards, web pages, application prototypes. The actual representations will depend on a number of factors such as the requirements from the group, the time available to the Crew to produce the models, etc.

During all breaks in the Park, the group uses a central bar area to get refreshment, eat a buffet lunch and dinner, and meet other people who are in The Park at the same time. These people are from the other group experiencing The Park at the same time, and some others are external consultants. The group discusses its idea and they share some of their findings and the group gets more knowledge to add to their discussions.

As we finish on Day Three, the group ends up in the bar area again to wind down and reflect on what they have achieved. The group can, if desired, book an incubator area in the same or adjacent building so that next week they can return and continue working through the plan they have just created. By just returning to the same location where it all began will fire up the enthusiasm and drive. This will be a direct contrast to returning to the office and being dragged back into business as usual. The Park offers a highly stimulating environment to continue driving until the launch.”

### Virtual Interactions

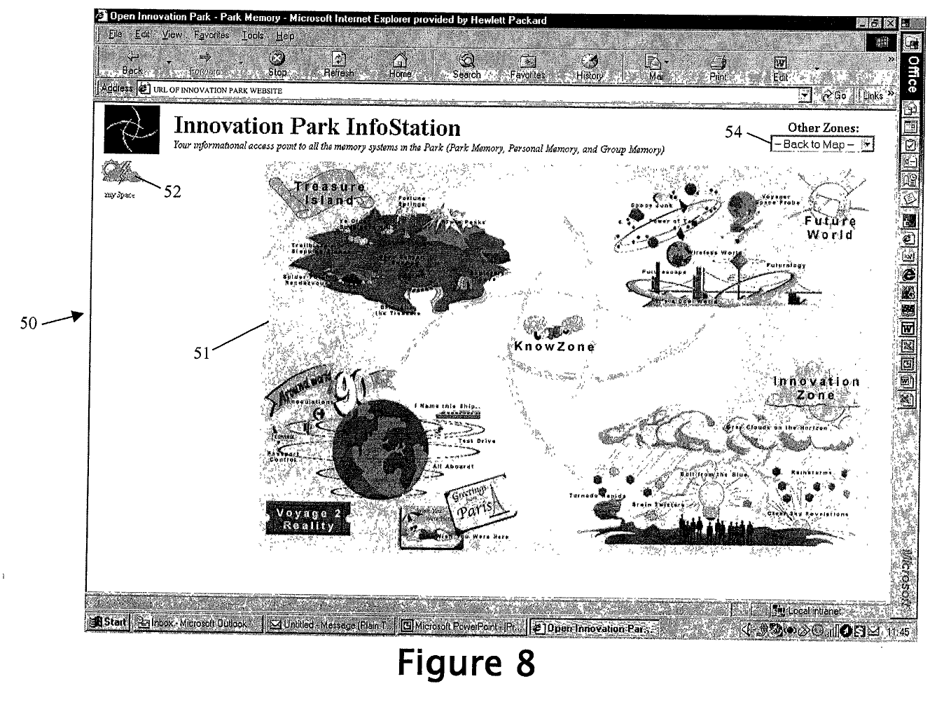

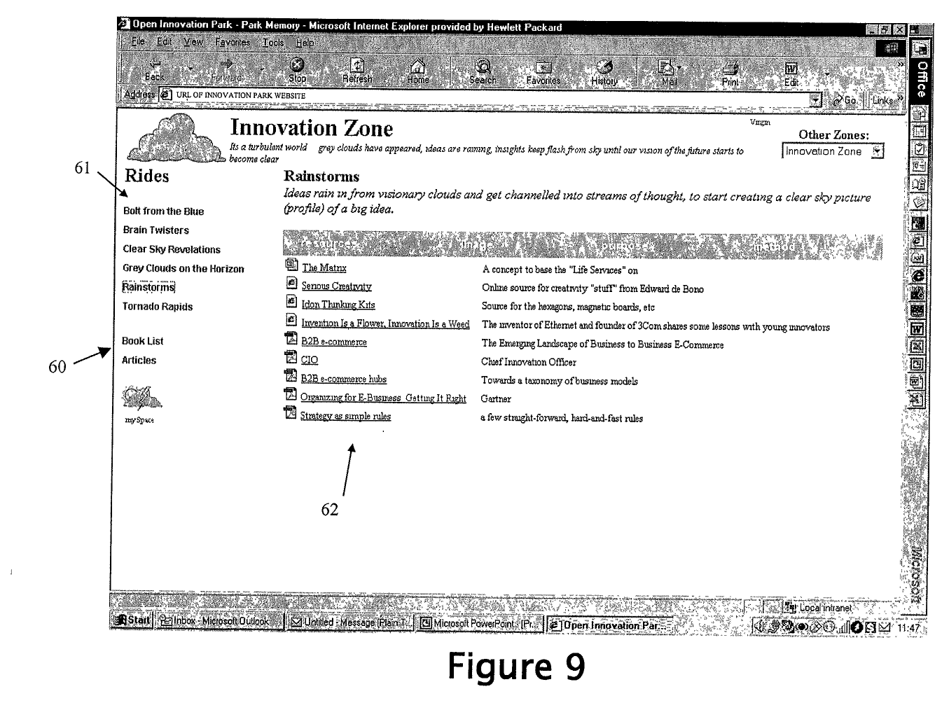

FIGS. 8 and 9 show screen shots for a “virtual” implementation of the Innovation Park. The basic operating principles of the Park are as described above but now groups/individuals experience the Innovation Park through a web interface. FIG. 8 depicts an opening screen 50 where the user is shown a map 51 of the Park, one or more icons 52 for accessing their own personal and group data areas, and a drop-down menu 54 for choosing a park zone. FIG. 9 depicts the Innovation Zone 60 with a list 61 of rides and a list 62 of the resources available for a selected ride (here, the “Rainstorms ride”).

The web interface permits the user to navigate around the four themed zones of the Innovation Park website user. Preferably, the user is given an “experience” by the use of 3D vrml technology and similar graphical technologies. The user can also visit the Know Zone where they can interact (by message exchange or voice) with other users currently using the virtual park. Users may also request to be put in contact with a consultant

Another important use of remote access technology is to keep participants up-to-date and in touch after conclusion of a visit to the park—in this respect, there will generally be follow-up tasks for participants and/or consultants to perform and the results of these task and activities can conveniently be posted to the project group space for all participants to access and input comments.

### Variants

It will be appreciated that many variants are possible to the above-described embodiments of the Innovation Park. For example, a greater or lesser number of themed zones can be provided and functionality differently divided between the zones. The central zone 15 need not, of course, be physically centrally located (though this is convenient) and, indeed, in some embodiments could be dispensed with entirely though this is not preferred; nevertheless, the association of the coordination role with the central zone can be removed in order to concentrate the role this zone on the informal exchange of ideas.

1. A business innovation park comprising a plurality of distinct interaction zones arranged as in a theme park and each providing resources and services in respect of a particular facet of developing a new business proposal from an initial idea to an execution plan, the park further comprising a core area for informal interaction between users of the park.

2. A park according to claim 1, wherein the park is established as a real physical environment on one site for users to walk around.

3. A park according to claim 1, further comprising an information technology infrastructure linked to and available in all said zones and said core area for collecting, collating and presenting data about a business idea as it is taken through the zones, the information technology infrastructure being accessible both to said users and to consultants operating in the park.

4. A park according to claim 1, wherein each zone is provided with sets of items, each set being adapted for a particular planned activity relevant to the purpose of the zone and being presented to reflect a specific aspect of a theme of the zone.

5. A park comprising a plurality of distinct interaction zones arranged as in a theme park and each providing resources and services in respect of a particular facet of developing a new business proposal from an initial idea to an execution plan, said zones comprising:
a future-world zone for experiencing leading edge technologies and/or simulations of future technology-enabled scenarios of potential relevance to the new business proposal;
an innovation zone for envisioning and conceptually exploring the new business proposal;
a treasure-island zone for examining the business case for the new business proposal;
a voyage-to-reality zone for evolving an execution plan for realising the new business proposal;
the business proposal potentially changing as a result of the activities in a zone, and the park further comprising a core area for informal interaction between users of the park.

6. A park according to claim 5, wherein the park is established as a real physical environment on one site for users to walk around.

7. A park according to claim 5, further comprising an information technology infrastructure linked to and available in all said zones and said core area for collecting, collating and presenting data about a business idea as it is taken through the zones, the information technology infrastructure being accessible both to said users and to consultants operating in the park.

8. A park according to claim 5, wherein each zone is provided with sets of items, each set being adapted for a particular planned activity relevant to the purpose of the zone and being presented to reflect a specific aspect of a theme of the zone.

9. A park according to claim 8, wherein the future-world zone is specifically themed on outer space, the innovation zone is specifically themed on weather, the treasure-island zone is specifically themed on a desert island, and the voyage-to-reality zone is specifically themed on travel.

10. A park according to claim 5, wherein the park is established as a real physical environment on one site for users to walk around with each zone being provided with sets of items where each set is adapted for a particular planned activity relevant to the purpose of the zone and is presented to reflect a specific aspect of a theme of the zone; the park further comprising an information technology infrastructure linked to and available in all said zones and said core area for collecting, collating and presenting data about a business idea as it is taken through the planned activities of the zones, the information technology infrastructure being accessible both to said users and to consultants operating in the park.

11. A park according to claim 5, wherein the core area is also adapted for providing guidance for a group taking its new business proposal around the park.

12. A park according to claim 7, further comprising hand-held mobile devices integrated into the information technology infrastructure and intended for user data input and output.

13. A park according to claim 7, wherein the information technology infrastructure is adapted to enable persons remote from the site to participate with users in the site in developing a business proposal.

14. A park according to claim 5, wherein the park is established as a virtual environment.

15. A method of operating a business innovation park of the form set out in claim 5, the method involving progressing users through the park according to the state of their business proposal on leaving a zone just visited, the user potentially re-visiting a zone one or more times as required for development of their business proposal.

16. A method of operating a business innovation park of the form set out claim 5, the method involving staffing the park with consultants to facilitate activities in the park zones and to coordinate progress around the zones.

17. A method of operating a business innovation park of the form set out in claim 5, the method involving establishing a collaboration between a user taking a business proposal through the park and at least one of:
another park user;
an internal consultant working in the park;
a visiting consultant or exhibitor;
an external party selected on the basis of their ability to assist in implementing the business proposal.

18. A business innovation system comprising four distinct interaction zones each providing resources and services for a respective one of the following activities concerning a new business idea:
experiencing of leading edge technologies and/or simulations of future technology-enabled scenarios of potential relevance to the new business idea;
envisioning and conceptually exploring the new business idea;
examining the business case for the new business idea;
evolving an execution plan for realising the new business idea;
the business idea potentially changing as a result of the activities in a zone.

19. A system according to claim 18, further comprising an information technology infrastructure linked to and available in all said zones for collecting, collating and presenting data about a business idea as it is taken through the zones.

20. A system according to claim 18, wherein the system further comprises a core area for informal interaction between users of the system and/or for providing guidance to users.

21. A system according to claim 18, wherein the system further comprises additional distinct zones concerning facets of developing the business proposal.

22. A system according to claim 18, wherein the system is established as a real physical environment on one site for users to walk around.

23. A system according to claim 19, further comprising hand-held mobile devices integrated into the information technology infrastructure and intended for user data input and output.

24. A system according to claim 19, wherein the information technology infrastructure is adapted to enable persons remote from the site to participate with users in the site in developing a business proposal.

25. A system according to claim 18, wherein the system is established as a virtual environment.

26. A business innovation method involving providing a plurality of distinct interaction zones arranged as in a theme park each with resources and services in respect of a particular facet of developing a new business proposal from an initial idea to an execution plan, and progressing a business proposal around the park according to the state of the business proposal on leaving a zone just visited, the business proposal potentially re-visiting a zone one or more times as required for development of the business proposal.

27. A method according to claim 26, further involving using an information technology infrastructure to collect, collate and present data about a business proposal as it is taken through the zones, the information technology infrastructure being accessible both to users and to consultants.

28. A method according to claim 26, wherein the zone activities take place at the same physical site.

29. A method according to claim 26, further involving providing an informal interaction area and giving users time to interaction informally in this area between sessions in the zones.

30. A method according to claim 26, wherein each zone is provided with sets of items, each set being adapted for a particular planned activity relevant to the purpose of the zone and being presented to reflect a specific aspect of a theme of the zone.

31. A method according to claim 26, the method involving providing consultants to facilitate activities in the zones and to coordinate progress around the zones.

32. A method according to claim 26, involving establishing a collaboration between a user taking a business proposal through the zones and at least one of:
another, un-related, user;
an internal consultant;
a visiting consultant or exhibitor;
an external party selected on the basis of their ability to assist in implementing the business proposal.

33. A business innovation method involving progressing a new business idea around four distinct interaction zones each providing resources and services for a respective one of the following activities concerning a new business proposal:
experiencing of leading edge technologies and/or simulations of future technology-enabled scenarios of potential relevance to the new business proposal;
envisioning and conceptually exploring the new business proposal;
examining the business case for the new business proposal;
evolving an execution plan for realising the new business proposal;
the business proposal potentially changing as a result of the activities in a zone.

34. A method according to claim 33, further involving providing an information technology infrastructure for collecting, collating and presenting data about a business proposal as it is taken through the zones, the information technology infrastructure being accessible both to users and to consultants.

35. A method according to claim 33, wherein the zone activities take place at the same physical site.

36. A method according to claim 33, further involving providing an informal interaction area and giving users time to interaction informally in this area between sessions in the zones.

37. A method according to claim 33, wherein each zone is provided with sets of items, each set being adapted for a particular planned activity relevant to the purpose of the zone and being presented to reflect a specific aspect of a theme of the zone.

38. A method according to claim 33, involving progressing users through the park according to the state of their business proposal on leaving a zone just visited, the user potentially re-visiting a zone one or more times as required for development of their business proposal.

39. A method according to claim 33, the method involving providing consultants to facilitate activities in the zones and to coordinate progress around the zones.

40. A method according to claim 33, involving establishing a collaboration between a user taking a business proposal through the zones and at least one of:
another user;
an internal consultant;
a visiting consultant or exhibitor;
an external party selected on the basis of their ability to assist in implementing the business proposal.
